(19) United States
(12) Patent Application Publication
(10) Pub. No.: US 2015/0085651 A1
(43) Pub. Date: Mar. 26, 2015

(54) ANALYSIS SERVER AND MOBILE NETWORK SYSTEM

(71) Applicant: HITACHI, LTD., Tokyo (JP)

(72) Inventors: Seiya KUDO, Tokyo (JP); Masato FUKUI, Yokohama (JP)

(21) Appl. No.: 14/328,098

(22) Filed: Jul. 10, 2014

(30) Foreign Application Priority Data
Sep. 26, 2013 (JP) 2013-199143

(51) Int. Cl. H04W 28/02

(52) U.S. Cl. CPC H04W 28/0247
USPC 370/230

(57) ABSTRACT

Congestion determination of a base station is not communicated based on a theoretical traffic amount, but higher accurate congestion determination is communicated based on an effective traffic amount which can be transmitted and received by the base station under an environment in which the base station is deployed.

### CROSS-REFERENCE TO RELATED APPLICATION

This application claims priority from Japanese Patent Application No. 2013-199143, filed Sep. 26, 2013, which is incorporated herein by reference in its entirety.

### BACKGROUND OF THE INVENTION

1. Field of the Invention

The present invention relates to an analysis server and a mobile network system, and particularly to a technique to control a bandwidth of a network based on a congestion status of a base station.

2. Description of Related Art

A mobile operator to manage a base station or the like of a mobile network system struggles to process traffic which increases with the rapid increase of smartphones. In general, as the traffic increases, the mobile operator increases capacity of equipment. However, under circumstances in which profit per user does not increase, the increase of the capacity of the equipment is not appropriate in view of cost-effectiveness. Then, the mobile operator not only increases the capacity of the equipment, but also considers that effective use of existing equipment is important and configures a system in which the traffic amount to be processed in the existing equipment, particularly in a base station is improved, and quality of experience per end user, for example, user throughput is improved. The mobile operator visualizes the congestion state of the base station by using this system, and when the base station is in the congestion state, the mobile operators controls the traffic of a particular user occupying the bandwidth, for example, a user downloading moving picture data, or controls a specific application such as a moving picture service.

In the foregoing system, when the congestion state of the base station is determined, the maximum throughput in design, which is determined by the specifications of the base station, is made a theoretical throughput, a threshold is determined based on the value, and when exceeding the threshold, it is determined that the base station is in the congestion state. In a general method, the traffic amount is controlled to a user in the base station which is determined to be in the congestion state or to an application.

As another prior art technique, JP-A-2007-43311 discloses a method of performing a congestion state control by regulation in a mobile network system, and the focus is made on the control to be performed after the congestion state is determined. Besides, JP-A-2012-231335 discloses a congestion state control performed in advance for a case where a congestion state occurs, for example, for New Year or an event such as a concert. Neither of the prior arts disclose a way of determining the congestion.

However, there are various types of base stations, and according to the installation environment, density of population, influence of adjacent building, communication hours, and the like, the communication can not be necessarily performed with the maximum throughput in design, that is, the theoretical traffic amount. In general, the amount of traffic transmitted and received by the base station is lower than the theoretical traffic amount. Thus, in the system in which the congestion state is determined based on the theoretical traffic amount, there may be a user performing communication in the congestion state since the state is not determined to be congested although the state is actually congested. As a result, quality of experience of end user is reduced.

### SUMMARY OF INVENTION

In order to solve the problem, according to an aspect of the invention, an analysis server in a mobile network system including a base station includes a calculation part which calculates statistics indicating a processing capacity of the base station based on a packet transmitted and received by the base station and calculates an effective statistics indicating an effective processing capacity of the base station based on the statistics, and a policy generation part which generates, based on the effective statistics, a policy for controlling traffic of the packet transmitted and received by the base station.

According to the aspect of the invention, congestion determination of a base station can be performed with high accuracy.

### BRIEF DESCRIPTION OF DRAWINGS

FIG. 1 is a figure showing a structural example of a mobile network system.

FIG. 2 is a functional block diagram of a DPI equipment.

FIG. 3 is a figure showing an example of a call processing signal packet.

FIG. 4 is a figure showing an example of a user data packet.

FIG. 5 is a figure showing an example of a packet for transmitting a terminal communication log.

FIG. 6 is a figure showing an example of a DPI log generated by the DPI equipment.

FIG. 7 is a figure showing an example of a communication terminal log notified by a communication terminal.

FIG. 8 is a functional block diagram of a communication log server.

FIG. 9 is a functional block diagram of an analysis server.

FIG. 10 shows an example of user data summarizing tables generated from the DPI logs of users in the same base station and from communication terminal logs.

FIG. 11 shows an example of a base station summarization table generated from the user data summarization tables in the same base station.

FIG. 12 shows an example of user data summarization tables generated from DPI logs of users moving between different base stations and from communication terminal logs.

FIG. 13 shows a first example of a base station summarization table generated from the DPI logs of the users moving between the different base stations and from the communication terminal logs.

FIG. 14 shows a second example of the base station summarization table generated from the DPI logs of the users moving between the different base stations and from the communication terminal logs.

FIG. 15 shows a third example of a base station summarizing table generated from the DPI logs of the users moving between the different base stations and from the communication terminal logs.

FIG. 16 is a flowchart showing a process of an analysis server.

FIG. 17 is a figure showing an example in which traffic is controlled.

### DESCRIPTION OF EMBODIMENTS

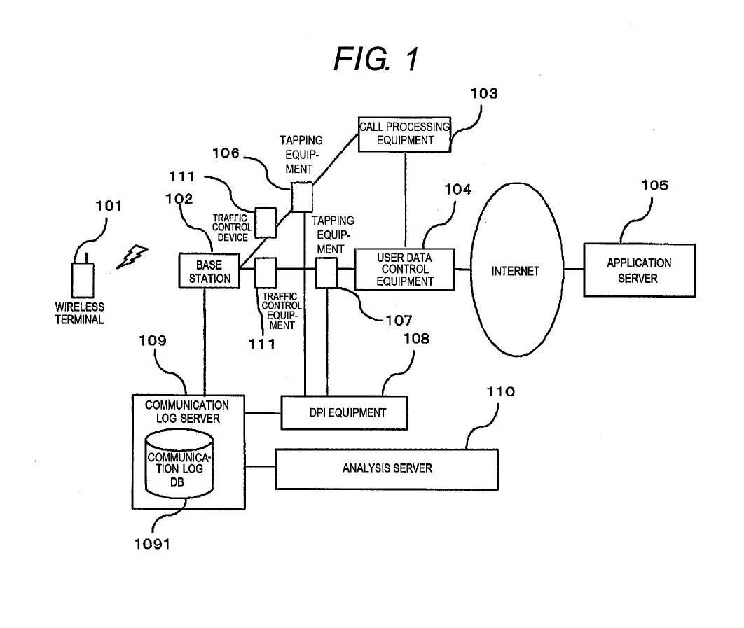

FIG. 1 is a figure showing a structural example of a mobile network system of an embodiment. A wireless terminal 101 is served by a base station 102. When starting communication, the wireless terminal 101 transmits a message signal for session connection to the base station 102. The base station 102 receiving the message signal for session connect from the wireless terminal 101 transmits the message signal to a call processing control equipment 103. The call processing control equipment 103 receiving the signal connects a session for transmitting and receiving user data. After the session for enabling the wireless terminal 101 to transmit and receive data for serving is connected, the wireless terminal 101 transmits user data to an application server 105 in order to be provided with the service. The user data transmitted from the wireless terminal 101 is transmitted to user data control equipment 104 via the base station 102. The user data control equipment 104 receiving the user data from the base station 102 converts a header format of the user data, and transmits to the application server 105 via the Internet.

As described above, the data transmitted from the wireless terminal 101 and data transmitted to the wireless terminal 101 pass through an interface between the base station 102 and the call processing control equipment 103 or an interface between the base station 102 and the user data control equipment 104. Thus, if all packets passing between the base station 102 and the call processing control equipment 103 and between the base station 102 and the user data control equipment 104 are captured, it is possible to visualize that “when” and “where” the wireless terminal 101 “uses what application” and “how is the feeling”. Then, tapping equipment 106 is installed between the base station 102 and the call processing control equipment 103, and tapping equipment 107 is installed between the base station 102 and the user data control equipment 104, and all packets passing through the routes are copied.

In order to determine the congestion in the system shown in FIG. 1, the tapping equipment 106 copies the packet flowing between the base station 102 and the call processing control equipment 103, and the tapping equipment 107 copies the packet flowing between the base station 102 and the user data control equipment 104, and the packets are transferred to a Deep Packet Inspection (DPI) equipment 108. The packet transferred from the tapping equipment 106 to the DPI equipment 108 includes the information necessary for the wireless terminal 101 to connect the session. Besides, the packet transferred from the tapping equipment 107 to the DPI equipment 108 includes the information relating to the user data between the wireless terminal 101 and the application server 105. The DPI equipment 108 extracts a terminal ID, a terminal machine type ID, a base station ID and the like from the packet transferred from the tapping equipment 106, and extracts an application in use, GPS information such as latitude and longitude necessary for the application, and the like from the packet transferred from the tapping equipment 107. The DPI equipment 108 combines the packets transferred from the tapping equipment 106 and the tapping equipment 107, specifies the application or the service used by the wireless terminal 101, and generates a DPI log as basic data of quality of experience. The generated DPI log is stored in a communication log DB 1091 in a communication log server 109.

On the other hand, the DPI log is data generated from the packet flowing through the mobile network. Thus, the GPS information such as latitude and longitude and the terminal machine type ID are not necessarily included. Then, in order to raise the precision of the system, the wireless terminal 101 is enabled to periodically transmit a terminal communication log between the wireless terminal 101 and the base station 102 to the communication log server 109. An application for the wireless terminal 101 to transmit the log is previously implemented, and the information collected by the application when the wireless terminal 101 communicates, for example, the GPS information such as latitude and longitude, terminal ID, terminal machine type ID, application in use, ID of the base station 102 in communication are transmitted to the communication log server 109. The communication log server 109 receiving the log information stores the log in the communication log DB 1091.

An analysis server 110 gets the DPI log and the terminal communication log stored in the communication log DB 1091, and summarizes statistics for each user and each base station. The analysis server 110 calculates an effective traffic amount based on the statistics summarized for each user and each base station. Further, a congestion evaluation is made based on the effective traffic amount. The result of the congestion evaluation is transferred to all of or part of the base station 102, the call processing control equipment 103, the user data control equipment 104 and a traffic control equipment 111 in FIG. 1, and control is performed by all of or part of the base station 102, the call processing control equipment 103, the user data control equipment 104 and the traffic control equipment 111 in FIG. 1.

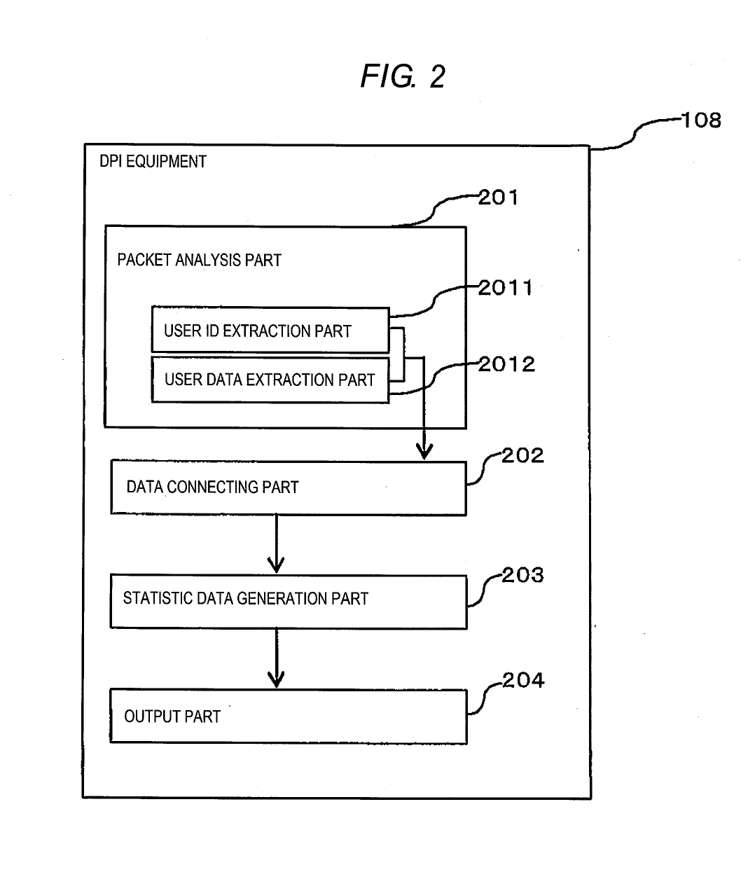

FIG. 2 is a functional block diagram of the DPI equipment 108. The DPI equipment 108 receives the copied and transferred packets from the tapping equipment 106 and the tapping equipment 107, and a packet analysis part 201 analyzes whether the received packet is the packet transferred from the tapping equipment 106 or the packet transferred from the tapping equipment 107. The packet analysis part 201 can also determine whether the packet is transferred from the tapping equipment 106 or the tapping equipment 107 by dividing an input port of the DPI equipment 108. After the packets are classified by the packet analysis part 201, a user ID extraction part 2011 extracts the terminal ID (user identifier) and the like included in the packet transferred from the tapping equipment 106, and a user data extraction part 2012 extracts the user data and the like included in the packet transferred from the tapping equipment 107.

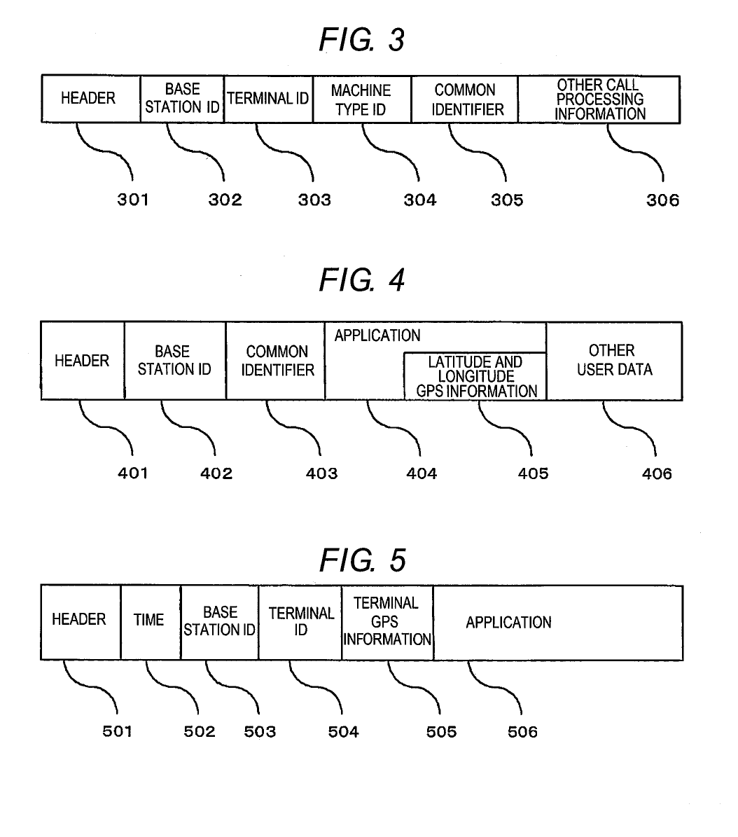

FIG. 3 is a figure showing an example of a packet format of the call processing signal packet transferred from the tapping equipment 106. As shown in FIG. 3, the call processing signal packet includes a header 301, a base station ID 302, a terminal ID 303, a machine type ID 304 indicating the machine type of the communication terminal, a common identifier 305 for linking the call processing signal packet and the user data packet, and other call processing information 306.

FIG. 4 is a figure showing an example of a packet format of the user data packet transferred from the tapping equipment 107. As shown in FIG. 4, the user data packet includes a header 401, a base station ID 402, a common identifier 403 for linking with the call processing signal packet, an information 404 relating to an application, and other user data 406. According to the application, GPS information 405 such as latitude and longitude is included in the application field 404. In order to connect these data, a common identifier, such as an IP address of the base station 102 included in any packet or a tunnel ID, is used. The identifier varies according to the communication system. Since the same value is included in the common identifier 305 shown in FIG. 3 and the common identifier 403 shown in FIG. 4, the common identifiers are used as keys, and the call processing signal packet and the user data packet are linked.

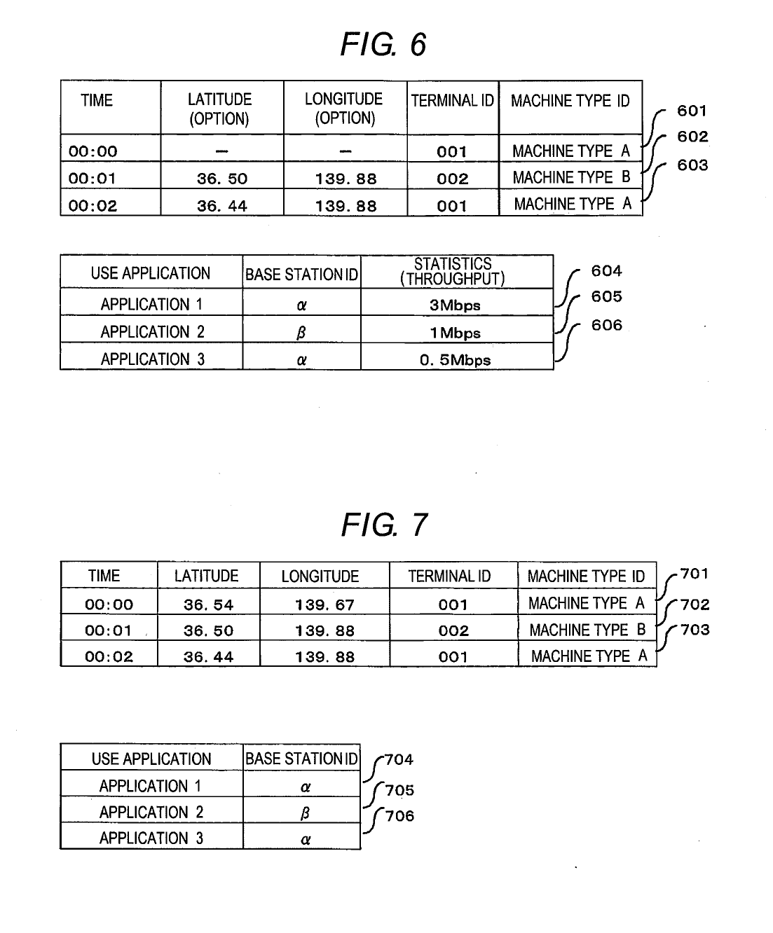

The DPI equipment 108 adds times when the DPI equipment 108 detects the respective packets to the information included in the call processing signal packet and the user data packet linked by using the common identifier, so that the respective information of time, latitude, longitude, terminal ID, machine type ID, use application and base station ID shown in FIG. 6 can be extracted as the DPI log. Besides, statistics such as a throughput of the user or a response time shown in FIG. 6 can be calculated from the length of packets received per unit time by the DPI equipment 108 and the sequence number specified by the protocol such as HTTP. Incidentally, the statistics may be any information as long as the processing capacity of the base station 102 is indicated, and may be information other than the throughput or the response time.

The DPI equipment 108 uses the common identifier, and a data connecting part 202 connects the terminal ID (user identifier) and the like with the user data and the like, so that it becomes possible to visualize that “when” the terminal “uses what application” and “how is the feeling”. The quality of experience of user (how the user feels) can be visualized by replacing the throughput of the user or the response speed of the application by response time.

Although the place is not necessarily notified according to the use application, if the application notifying the GPS information is used, the position information such as latitude and longitude can be captured from the packet. The DPI equipment 108 uses the data connected by the data connecting part 202, and a statistic data generation part 203 generates the statistics such as user throughput in the application actually used by the terminal or the response time to the application server 105. A DPI log 81 generated by the DPI equipment 108 is transferred from an output part 204 to the communication log server 109.

As described above, the position information such as latitude and longitude is not necessarily included in the DPI log 81 generated by the DPI equipment 108. Then, the DPI log 81 can be complemented by implementing an application into the wireless terminal 101, which transfers, as a terminal communication log 82, a log in communicated between the wireless terminal 101 and the base station 102 to the communication log server 109 when the wireless terminal 101 communicates. The transfer of the terminal communication log 82 is enabled by implementing the specific application into the wireless terminal 101 in advance.

FIG. 5 is a figure showing an example of a packet transmitted from the application which is implemented in the wireless terminal 101 in order to generate the communication terminal log 82. The packet for generating the communication terminal log 82 includes a header 501, a time 502 when the packet is transmitted, a base station ID 503, a terminal ID 504, a terminal GPS information 505, and an application 506 which is not the application used for generating the communication terminal log but is the application used in the service received by the user at the time. The communication log server 109 receiving the packet generates the communication terminal log 82 shown in FIG. 7 from the packet.

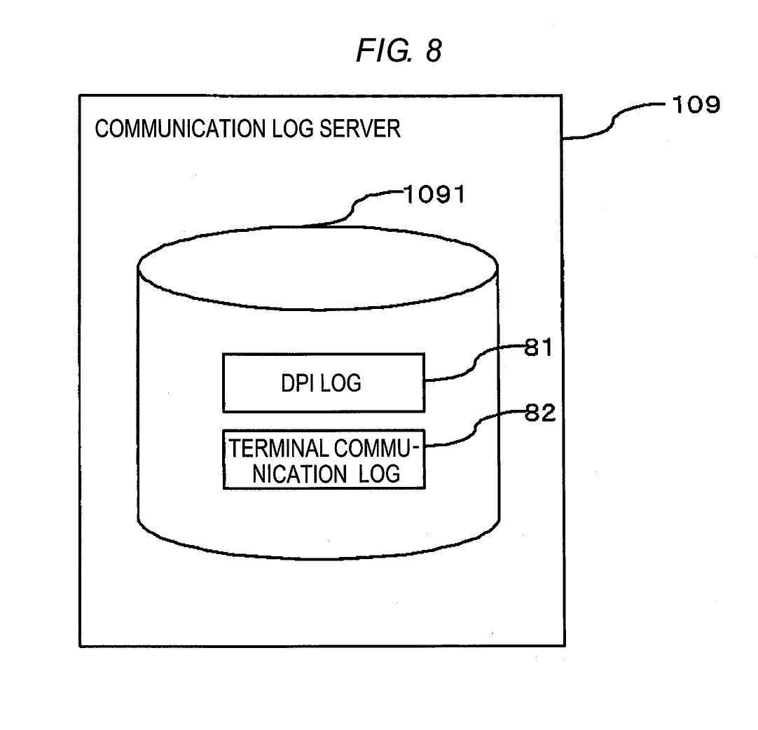

FIG. 8 is a block diagram showing a structure of the communication log server 109. The communication log server 109 includes the communication log DB 1091, and stores the DPI log 81 and the terminal communication log 82.

FIG. 6 is a figure showing an example of the DPI log 81 stored in the communication log server 109. The example of the DPI log 81 shown in FIG. 6 includes time, terminal ID (user identifier), machine type ID, use application, base station ID, and statistics (throughput in this example). GPS information such as latitude and longitude is collected and stored by the application if possible. In the table of FIGS. 6, 601 and 604, 602 and 605, and 603 and 606 respectively form pairs. For convenience, the two tables are shown. The time, the terminal ID (user identifier), the machine type ID, the use application, the base station ID, and the statistics are stored at the rows 601 and 604. Since the latitude and longitude information can not be collected from the packet, it is treated as missing data. The same user generates the log at the rows 603 and 606, and at this time, since the GPS information can be collected from the packet, the GPS information is shown in the table.

FIG. 7 is a figure showing an example of the terminal communication log 82 stored in the communication log server 109. The example of the terminal communication log shown in FIG. 7 includes time, latitude, longitude, terminal ID, machine type ID, use application, and base station ID. The log is the log collected from the wireless terminal 101 by using the specific application, and communication data of the wireless terminal 101 is periodically transmitted to the communication log server 109 at the time of use of the application. In the table of FIGS. 7, 701 and 704, 702 and 705, and 703 and 706 respectively form pairs. For convenience, the two tables are shown.

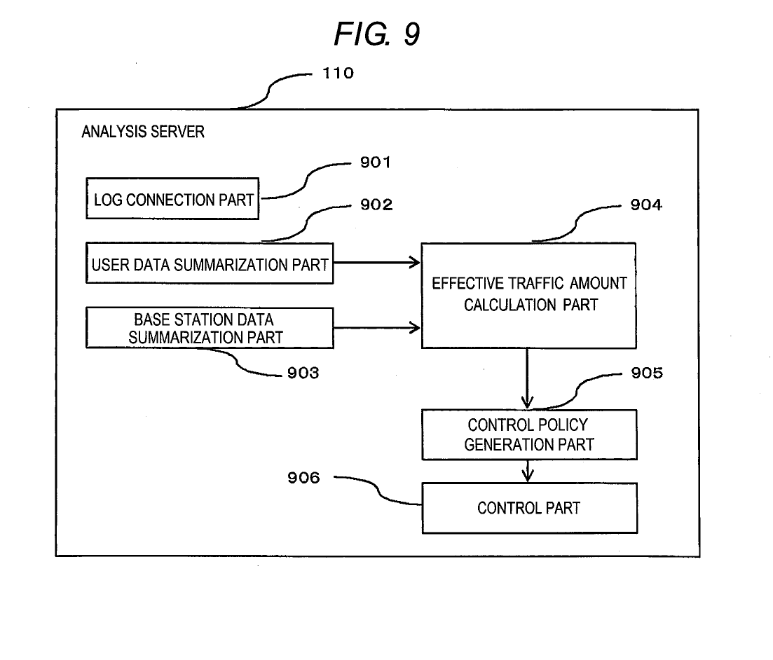

FIG. 9 is a block diagram showing a structure of the analysis server 110. The analysis server 110 includes a log connection part 901, a user data summarization part 902, abase station data summarization part 903, an effective traffic amount calculation part 904, a control policy generation part 905 and a control part 906. The analysis server periodically collects the DPI log 81 and the terminal communication log 82 stored in the communication log server 109 and calculates the effective traffic amount.

Incidentally, any of the DPI equipment 108, the communication log server 109 and the analysis server 110 described in FIG. 2, FIG. 8 and FIG. 9 are realized by general server equipments, and include, although not shown, a CPU, a memory, a hard disk, and a communication interface for communicating with another equipment. The respective function parts such as the packet analysis part 201 and the log connection part 901 are realized by, for example, the CPU which executes a program stored in the memory. Besides, the communication log DB 1091 storing the DPI log 81 and the terminal communication log 82 is realized by, for example, the hard disk.

The analysis server 110 connects the collected DPI log 81 and the terminal communication log 82 by the log connection part 901, and the logs are summarized by the user data summarization part 902 for the same terminal ID (user identifier) and are summarized by the base station data summarization part 903 for the same base station. When the DPI log 81 and the communication terminal log are connected by the user data summarization part 902 and the base station data summarization part 903, the logs are connected based on data as a common item in any data such as the terminal ID, the machine type ID and the base station ID in communication. In addition, information existing in only one of the logs, for example, the statistics and the position information are added. Based on the summarized data, the effective traffic amount calculation part 904 calculates the effective statistics when the user communicates or communicates via the base station. Based on the effective traffic amount calculated by the effective traffic amount calculation part 904, the control policy generation part 905 generates a control policy for the traffic control equipment 111 and the like to actually control. The policy generated by the control policy generation part 905 is notified to the traffic control equipment 111 and the like via the control part 906.

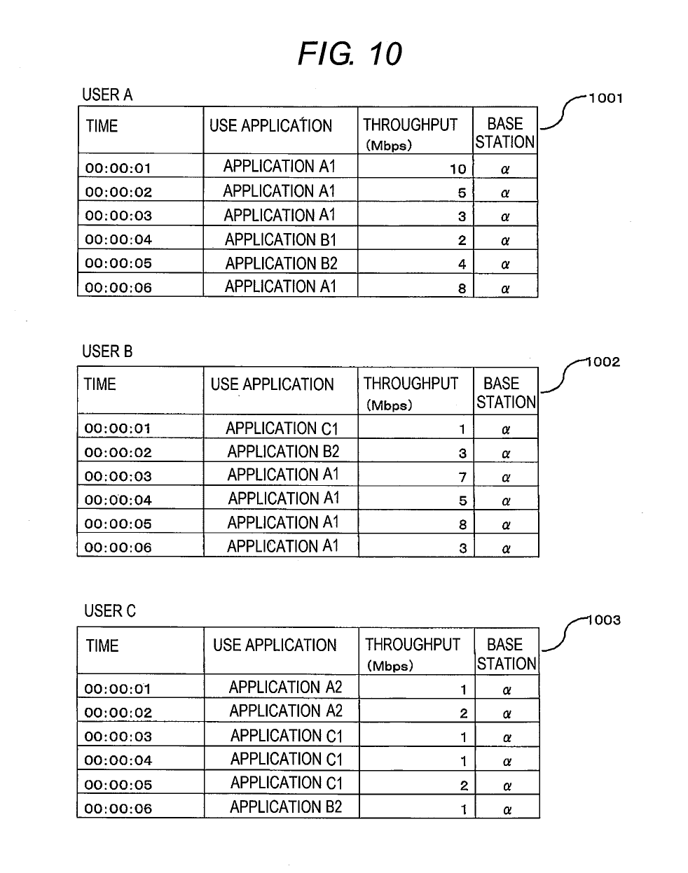

FIG. 10 is a view showing examples of user data summarization tables 1001, 1002 and 1003 generated by the user data summarization part 902 from the DPI log 81 and the terminal communication log 82. Time, use application, statistics (user throughput in this example), and information of base station which wireless terminals connect are stored in respective columns of the user data summarization tables 1001, 1002 and 1003. Summarization results in a specified unit time (one second in this example) are stored in respective rows. The information is summarized for each of the user A1001, the user B1002 and the user C1003. The user here corresponds to the terminal ID of the DPI log 81 or the communication terminal log 82, and the respective data are summarized for each terminal ID.

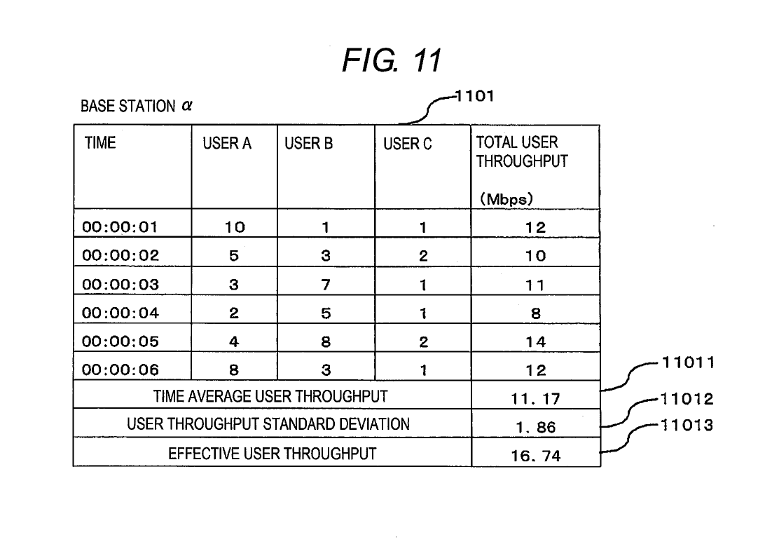

FIG. 11 is a figure showing an example of a base station data summarization table 1101 generated such that the base station data summarization part 903 summarized data for the same base station based on the user data summarization table 1001. The respective items enumerated in the base station data summarization table 1101 shown in FIG. 11 are merely examples. The items shown in respective columns of the base station data summarization table 1101 include statistics of each of the user A, the user B, and the user C, in this example, user throughputs and the total user throughputs of the three users of the user A, the user B and the user C are listed. The summarization result in a specified unit time (one second in this example) is stored in each row.

Subsequently, the effective traffic amount calculation part 904 obtains a time average user throughput 11011 in the base station and a standard deviation 11012 of the user throughput based on the data of the base station data summarization table 1101 shown in FIG. 11. Besides, an effective user throughput 11013 is obtained by using the time average user throughput 11011 and the user throughput standard deviation 11012. In the example shown in FIG. 11, the effective user throughput 11013 is a value obtained by adding a value three times larger than the user throughput standard deviation to the time average user throughput 11011. The effective user throughput 11013 can also be calculated by using another function by a method other than the above.

Here, the effective user throughput 11013 means a maximum throughput at which the user communicating through the base station can communicate. In general, connection speed is lower than the theoretical specification of the base station because of the deployment environment of the base station, time zone, weather and the like. The effective user throughput is obtained after considering the condition and is the maximum throughput at which the user can communicate. The effective statistics such as the effective user throughput is a value lower than the design specifications, and the value means a realistic value which can be actually felt by the user. In the effective user throughput used in this example, the throughput felt by the user is obtained based on the packet flowing through the actual network and the log from the user terminal, and the throughput in view of variation of the throughput (value three times larger than the standard deviation is added) is defined as the effective throughput.

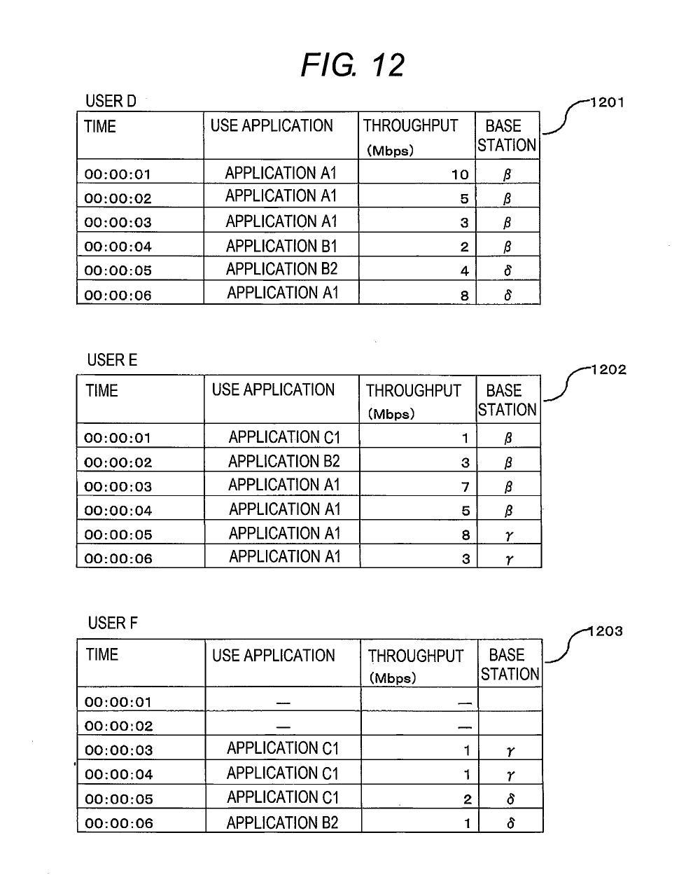

FIG. 12 is a figure showing another example of the user data summarization table. FIG. 12 assumes a case in which the user communicates with different base stations in respective times or a case including a time when the user does not communicate. A user D and a user E of FIG. 12 are examples of users moving between two base stations, and a user F is an example including a communication time in addition to the case of moving between base stations. In the user D, a base station which user D connects is changed from β to δ at time 00:00:05 in the user data summarization table 1201. In the user E, a base station which user E connects is changed from β to γ at time 00:00:05 in the user data summarization table 1202. In the user F, who does not communicate until time 00:00:02 in the user data summarization table 1203, communication starts at a base station γ from time 00:00:03, and the base station is changed from γ to δ at time 00:00:05.

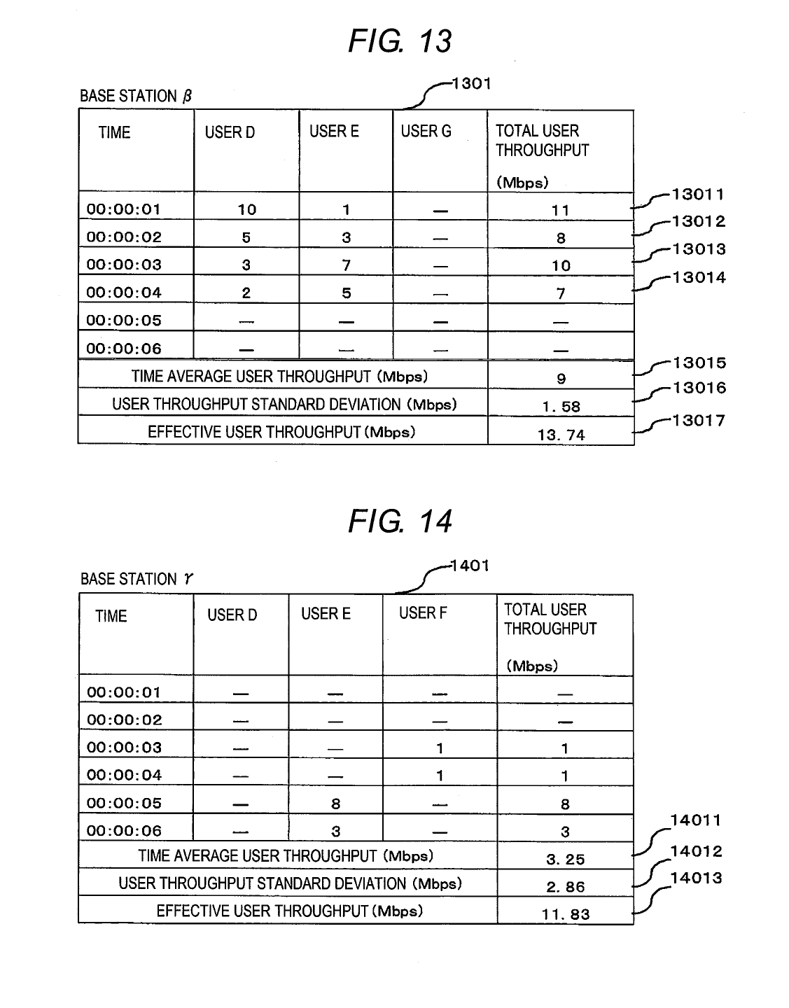

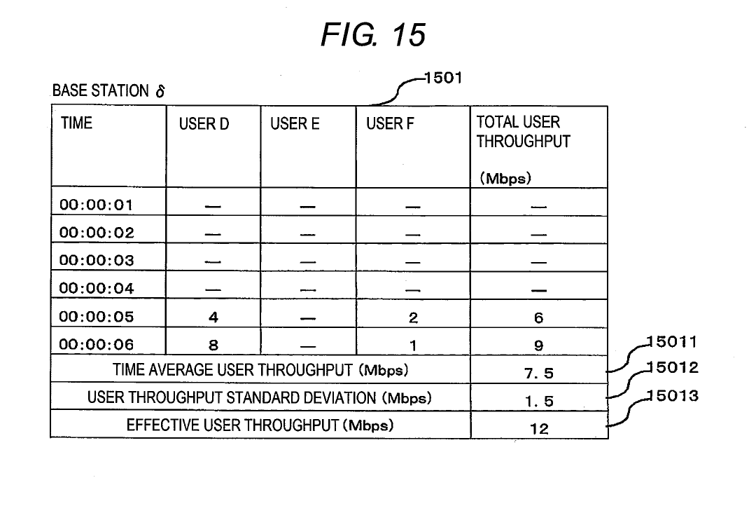

Base station summarization tables for three users, in which summarization is performed for each base station, are denoted by 1301 of FIG. 13, 1401 of FIGS. 14 and 1501 of FIG. 15. Similarly to FIG. 11, data of the users in the base station β are summarized in FIG. 13, data of the users in the base station γ are summarized in FIG. 14, and data of the users in the base station δ are summarized in FIG. 15.

When the time average user throughput is obtained in each of the base stations, the division is made using a time when the users actually communicate. That is, in the base station β, a total user throughput 13011 at time 00:00:01, a total user throughput 13012 at time 00:00:02, a total user throughput 13013 at time 00:00:03, and a total user throughput 13014 at time 00:00:04 are added to each other and are divided by 4 of the communication time. That is, (11+8+10+7)/4=9 is obtained, and 9 Mbps is a time average user throughput 13015. Similarly, variance is calculated from the second central moment, and a user throughput standard deviation 13016 is obtained as the square root of the variance. Similarly to FIG. 11, an effective user throughput 13017 is calculated by adding a value three times larger than the user throughput standard deviation 13016 to the time average user throughput 13015.

Similarly, with respect to the base station γ, a time average user throughput 14011, a user throughput standard deviation 14012 and an effective user throughput 14013 are calculated in the base station summarization table 1401 of FIG. 14. With respect to the base station δ, a time average user throughput 15011, a user throughput standard deviation 15012 and an effective user throughput 15013 are calculated in the base station summarization table 1501 of FIG. 15.

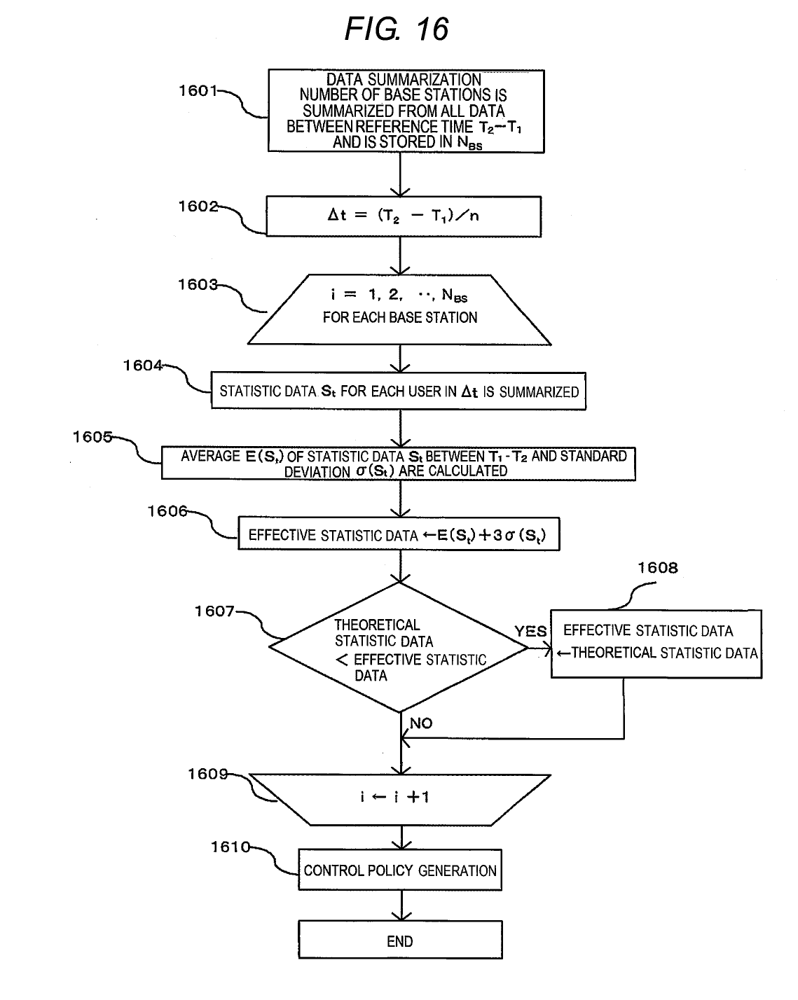

FIG. 16 is a flowchart showing a series of processes in which the analysis server calculates an effective user throughput for each base station, and generates a control policy. FIG. 16 is also the flowchart in which the series of processes explained in FIG. 10 to FIG. 15 are generalized.

In the data summarization, reference time T1 and T2 are determined in order to determine a measurement time, and the number of base stations in which summarization is performed during the time is counted (step 1601). Next, the measurement time is divided into n parts, and the unit time Δt is calculated (step 1602). A procedure from step 1603 to step 1609 is a loop for obtaining the effective user statistics in each base station. In the loop, first, statistic data St for respective users are summarized in each Δt (step 1604). This step corresponds to, for example, the process of summarizing the throughputs of the users A, B and C and the total user throughputs at time 00:00:01 to 00:00:06 in FIG. 11. Next, an average E (St) of the statistic data and a standard deviation σ(St) for the respective users between the measurement time T1 and T2 are calculated (step 1605). This step corresponds to, for example, the process of calculating the time average user throughput 11011 and the user throughput standard deviation 11012 in FIG. 11. The effective user statistics is calculated based on E(St) and σ(St) (step 1606). This step corresponds to, for example, the process of calculating the effective user throughput 11013 in FIG. 11. Here, in this embodiment, the effective user statistics is calculated by E (St)+3σ(St). However, the effective user statistics calculated at step 1606 is an example, and can also be treated as a general function. If the effective user statistics calculated at step 1606 is larger than the theoretical statistics, the effective user statistics is replaced by the theoretical user statistics (step 1607, step 1608). The theoretical user statistics are a theoretically achievable numerical value in design, which is determined according to the equipment, for example, the specifications of the base station and is, for example, a throughput or a response time. This process is performed for all base stations (step 1609).

In this embodiment, although the user throughput is used as an example of the statistics, a statistics other than the user throughput, for example, a response time between the communication terminal 101 and the application server 105 or a communication time can also be selected as the statistics. When the calculation is ended for all the base stations, a control policy used for control by the call processing control equipment 103, the user data control equipment 104 and the traffic control equipment 111 is generated based on the effective user statistics for the respective base stations (1610). When the control policy is notified from the analysis server 110, the call processing control equipment 103, the user data control equipment 104 and the traffic control equipment 111 control the traffic for the base station based on the control policy, or the base station itself controls the traffic from the wireless terminal 101.

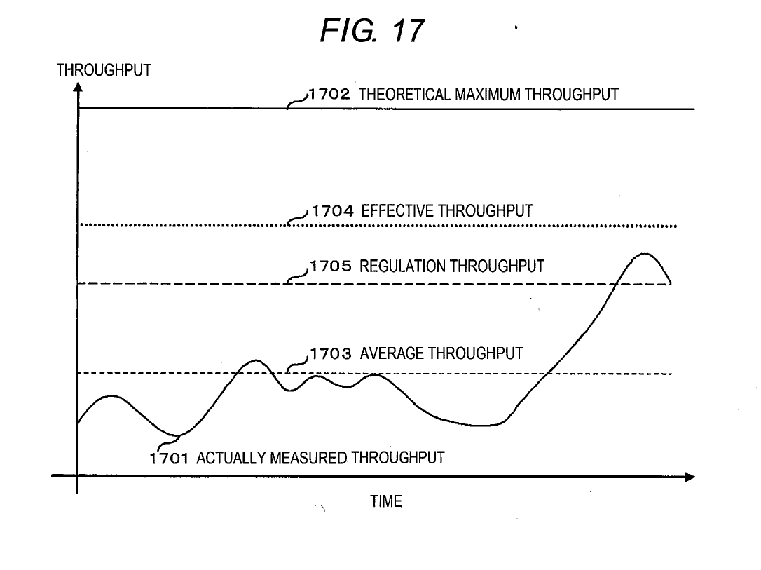

FIG. 17 is a view showing an example in which the traffic is controlled by the call processing control equipment 103, the user data control equipment 104 and the traffic control equipment 111. In FIG. 17, based on an actually measured throughput 1701, an average throughput 1703 in the time and an effective throughput 1704 are calculated. Besides, a theoretical throughput 1702 is a known value and is a higher value than the effective throughput 1704 in this example. At this time, it is assumed that the maximum throughput achieved in the base station is the effective throughput 1704, and the congestion degree of the base station is determined based on the effective throughput 1704.

It is conceivable that for example, a value of 90% of the effective throughput is determined to be a regulation throughput. Alternatively, since the effective throughput 1704 is the throughput obtained by adding a value three times larger than the standard deviation to the average throughput 1703, it is conceivable that the throughput obtained by adding a value two times larger than the standard deviation to the average throughput 1703 is determined to be the regulation throughput 1705. When the throughput exceeds the regulation throughput, the control policy is notified to the base station 102 or the adjacent traffic control equipment 111 and regulation is applied.

For example, many users exist in the base station 102, and there is a case where apart of user communicates of a large amount of data. If the user can be identified, the control policy of allocating narrower bandwidth of only the user can be notified to the base station 102. When all users uniformly communicate, the control policy of allocating to uniformly regulate transmission can also be notified to the base station 102.

Besides, when the throughout exceeds the regulation throughput, the control policy of instructing to prevent the traffic larger than the regulation throughput from being transmitted to the base station 102 can also be notified to the traffic control equipment 111.

As described above, according to the embodiment, the congestion determination of the base station is not performed based on the theoretical traffic amount, but the accurate congestion determination closer to the user experiencing can be communicated based on the effective traffic amount which can be transmitted and received by the base station under the environment in which the base station is deployed.

Besides, according to the embodiment, the accuracy of congestion determination can be improved and the equipment use efficiency of the base station or the like can be raised. Since the equipment use efficiency is improved, the operator can suppress equipment investment, while the user can receive the best service which can be received at each time irrespective of the area and time. Since quality of experience of user is visualized and controlled, the operator further classifies customers and can realize a premium service and the like.

What is claimed is:

1. An analysis server in a mobile network system including a base station, comprising:
a calculation part which calculates a statistics indicating a processing capacity of the base station based on a packet transmitted and received by the base station and calculates an effective statistics indicating an effective processing capacity of the base station based on the statistics; and
a policy generation part which generates, based on the effective statistics, a policy for controlling traffic of the packet transmitted and received by the base station.

2. The analysis server according to claim 1, wherein the calculation part calculates a user throughput as the statistics, and calculates an effective user throughput as the effective statistics.

3. The analysis server according to claim 2, wherein the calculation part calculates the effective user throughput based on an average value of the user throughput per unit time and a standard deviation.

4. The analysis server according to claim 1, wherein if the effective processing capacity exceeds a theoretical processing capacity determined according to specifications of the base station, the calculation part calculates to cause the theoretical processing capacity to become the effective statistics.

5. The analysis server according to claim 1, wherein the policy generation part calculates regulation statistics for controlling traffic based on the effective statistics.

6. The analysis server according to claim 5, further comprising a control part which notifies the policy to at least one of the base station and a traffic control equipment connected to base station if the traffic of the packet transmitted and received by the base station exceeds the regulation statistics.

7. The analysis server according to claim 6, wherein the control part notifies the base station of the policy to allocate to narrower a bandwidth of a wireless terminal connected to the base station or to regulate transmission from the wireless terminal.

8. The analysis server according to claim 6, wherein the control part notifies the traffic control equipment of the policy to instruct to prevent the traffic exceeding the regulation statistics from being transmitted to the base station.
